(19) United States
(12) Patent Application Publication
(10) Pub. No.: US 2013/0054491 A1
(43) Pub. Date: Feb. 28, 2013

(54) COST OPTIMIZED SOLUTION FOR A PRINT ORDER

(71) Applicants: EHUD CHATOW, Palo Alto, CA (US); Andrew E. Fitzhugh, Menlo Park, CA (US); Eric Hoarau, San Francisco, CA (US)

(72) Inventors: EHUD CHATOW, Palo Alto, CA (US); Andrew E. Fitzhugh, Menlo Park, CA (US); Eric Hoarau, San Francisco, CA (US)

(21) Appl. No.: 13/219,898

(22) Filed: Aug. 29, 2011

(51) Int. Cl. G06Q 30/00

(52) U.S. Cl. 705/400

(57) ABSTRACT

One example discloses a system comprising a memory for storing machine readable instructions and a processing unit for accessing the memory and executing the machine readable instructions. The machine readable instructions can comprise a print order hub to determine a cost optimized solution for fulfilling a print order. The determination of the cost optimize solution can be based on a calculation of a price charged for preparing material for the print order and shipping the material for the print order to a destination identified in the print order for a plurality of print service providers.

### BACKGROUND

Print on demand (POD), sometimes referred to as publish on demand, is a printing technology and business process in which new copies of a document (e.g., a book, a magazine, a pamphlet, etc.) are printed after an order has been received. A print service provider (PSP) is a factory (e.g., businesses) that can process and fulfill POD orders. In one example, the PSP can receive a POD order, and print a document requested in the POD order. The PSP can include capabilities to print in color, bind printed documents, print in multiple languages, print on different types of paper, etc. Moreover, the PSP can ship a completed print job of a POD order to another entity (e.g., a customer).

### BRIEF DESCRIPTION OF THE DRAWINGS

FIG. 1 illustrates an example of a system for managing a print order over a network.

FIG. 2 illustrates an example of a price table.

FIG. 3 illustrates an example of a price update table.

FIG. 4 illustrates an example of data included with a print order.

FIG. 5 illustrates an example of a print order system.

FIG. 6 illustrates an example of a flow chart of a method for managing a print order.

FIG. 7 illustrates another example of a flowchart of a method for managing a print order.

FIG. 8 illustrates an example of a computer system that can be employed to implement the systems and methods illustrated in FIGS. 1-7.

### DETAILED DESCRIPTION

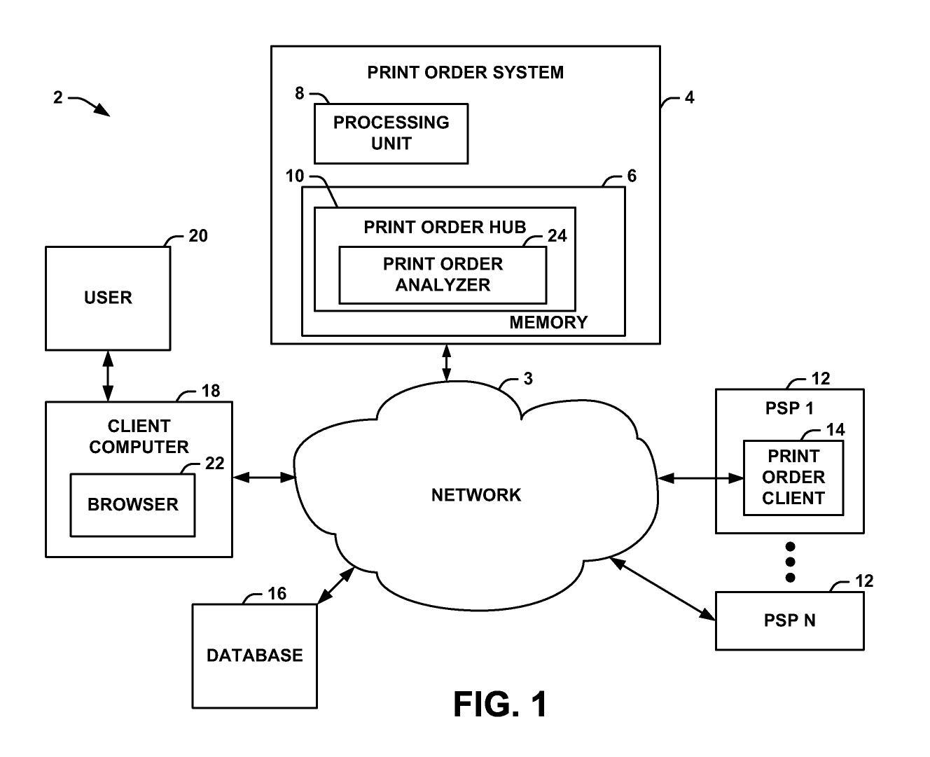

FIG. 1 illustrates an example of a system 2 for managing a print order over a network 3. The print order can be a request for a relatively large and/or complex print job, such as book and/or magazine printing and/or shipping. The print order can be implemented, for example as a print on demand request. The network 3 could be implemented, for example as a network that employs the Transmission Control Protocol/Internet Protocol (TCP/IP), Internet Protocol version 6 (IPv6), etc. In some examples, the network 6 could be implemented as the Internet, and/or a mobile network. A print order system 4 can be coupled to the network 3 and can communicate with other nodes on the network 3.

The print order system 4 can include a memory 6 for storing machine readable instructions and a processing unit 8 for accessing the memory 6 and executing the machine readable instructions. The memory 6 could be implemented, for example, as volatile memory (e.g., random access memory) or nonvolatile memory (e.g., a hard drive, flash memory, etc.). The processing unit 8 can include a processing core.

In one example, the machine readable instructions can include a print order hub 10. The print order hub 10 can communicate with N number of print service providers (PSPs) 12 that can receive and fulfill print orders, wherein N is an integer greater than or equal to two. In some examples, the print order hub 10 can include functionality to operate as a receiver and director of a print job, based on efficient routing.

Each PSP 12 can include a print order client 14 that communicates with the print order hub 10 over the network 3. For purposes of simplification of explanation, only the print order client 14 included in PSP 1 of the PSPs 12 is shown and described herein, but it is to be understood that PSPs 2-N of the PSPs 12 can also include a print order client 14. Each PSP 12 can provide certain printing options, including but not limited to format, finishing, ink type, substrate, language, lead time, production capacity, value added services, etc. For instance, in one example, PSP 1 of the PSPs 12 can include capabilities of printing in color, multiple types of paper, multiple types of bindings, etc. The PSP 1 of the PSPs 12 can have costs associated with the different capabilities, as well as costs associated with fulfilling the print order within a specific timeframe. The costs can be reflected in a price charged by the PSP 1 of the PSPs 12 to fulfill the print order with certain specifications. PSP 1 of the PSPs 12 can provide the print order client 14 with a price table that reports these prices. The prices can reflect both the cost and an acceptable margin (e.g., profit margin) for preparing material for the print order.

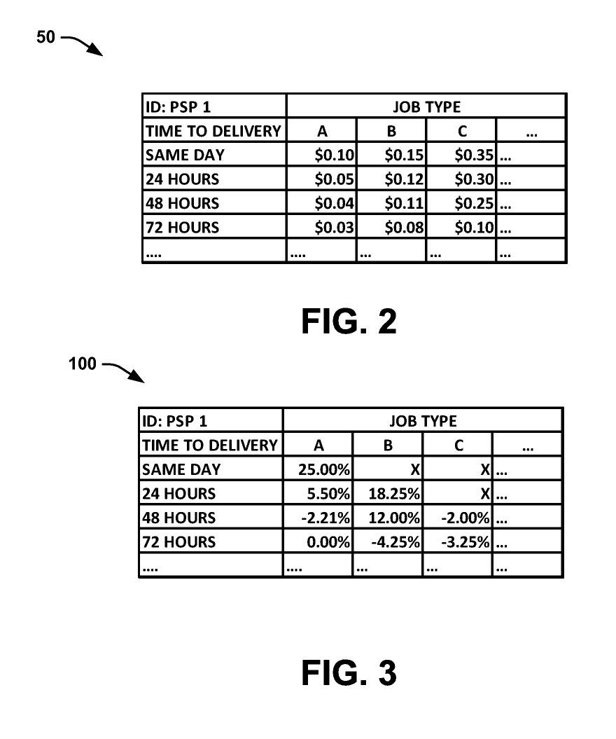

FIG. 2 illustrates an example of a price table 50 that could be employed as the price table for PSP 1 of the PSPs 12 illustrated in FIG. 1. The price table 50 could be implemented, for example, as a matrix. In the example illustrated in FIG. 2, a time to delivery (e.g., timeframe) is referenced against a job type to provide a price per page. The time delivery can represent, for example, a time to prepare (e.g., print and bind) material for a print order and to send the material for the print order to a point of shipment (e.g., a shipping facility). Each job type (e.g., job type ‘A’, ‘B’ and ‘C’ in FIG. 2) can represent a particular specification of printing and order size. In one example, job type ‘A’ could represent printing in black and white on newsprint paper without binding. In another example, job type ‘B’ could represent printing in black and white on relatively high-quality paper (e.g., a paper with a high opacity) with a book binding. In yet another example, job type ‘C’ could represent printing in color on glossy paper (e.g., magazine paper) with a magazine binding. Although only job types ‘A’, ‘B’ and ‘C’ are shown and described, it is to be understood that the price table 50 can include any number of job types. The price table 50 can also include an ID that specifically identifies PSP 1, which ID is labeled in FIG. 2 as “ID: PSP 1.”

Referring back to FIG. 1, each PSP 12 can provide and/or update a price table to the print order client 14 on a relatively infrequent basis (e.g., once or twice a year). In response, the print order client 14 can provide the price table to the print order hub 10, which can store a price table for a given PSP 12 in a PSP record associated with the given PSP 12, which PSP record can be stored in a database 16 accessible via the network 3. Although FIG. 1 illustrates the database 16 as being external to the print order system 4, in other examples, the database 16 could be integrated with the print order system 4.

Additionally, due to seasonal changes, the prices associated with preparing a specific job type in a specific timeframe and quantity can change with relative frequency. For instance, during a peak printing season, a given PSP 12 may be operating at nearly full capacity. In such times it may be desirable and/or necessary for the given PSP 12 to raise prices for specific job types provided within specific timeframes. Conversely, in non-peak seasons (e.g., “slow times”) it may be desirable and/or necessary for the given PSP 12 to lower prices to raise additional revenue. Additionally, the PSP may choose to raise or reduce the price of individual product based on a variety of factors. Accordingly, in some examples, in between times that a price table is updated (e.g., once a week or once a day) each PSP 12 (or some portion thereof) can provide a price update table to the print order client 14, which in turn can communicate the price update table to the print order hub 10. Upon receipt of a price update table from a given PSP 12, the print order hub 10 can store the price update table in the PSP record associated with the given PSP 12. In such a situation, a given PSP 12 can select a percentage of change of price for a given job type (e.g., quantum steps defined in a corresponding price table) based on the current and/or future expected production at the given PSP 12.

In other examples, the print order hub 10 can generate and/or modify the price update table for the given PSP 12. In this situation, the given PSP 12 can determine a production parameter based on an estimated production capacity and/or other per job type metric for the given PSP 12. The given PSP 12 can communicate the production parameter to the print order hub 10. In response, the print order hub 10 can select a percentage of change of price for a given job type based on the production parameter, data in a corresponding price table for the PSP (e.g., the price table stored in the PSP record associated the given PSP) and/or a factory status for the given PSP 12. In some examples, the print order hub 10 can receive a price per level of the production parameter from the given PSP that can facilitate the selecting of the percentage of change of price. Upon generation of the price update table for the given PSP 12, the print order hub 10 can store the price update table in the PSP record associated with the given PSP 12.

FIG. 3 illustrates an example of a price update table 100 that could be employed as the price update table for PSP 1 of the PSPs 12 illustrated in FIG. 1. The price update table 100 can be implemented as a matrix, in a manner similar to the price table 50 illustrated in FIG. 2. Each cell in the price update table can correspond to a cell in the price table 50 illustrated in FIG. 2. In the example illustrated in FIG. 2, a time to delivery is referenced against a job type to provide a percentage of change of price. Each percentage of change of price can represent an increase (if percentage number is positive) or decrease (if percentage number is negative) in price associated with preparing (e.g., printing and/or binding) material for a particular type of job and delivering the material with in a particular timeframe to a point of shipment. For instance, in FIG. 3, the price update table 100 shows a change of 25.00% for preparing job type ‘A’ the same day. In the present example, such a percentage could indicate that the price listed for preparing material of job type ‘A’ the same day is increased by 25.00% per page. Thus, the price per page would be $0.125 per page instead of $0.10 per page, as illustrated in FIG. 2. Similarly, in the example illustrated in FIG. 3, preparing material for job type ‘B’ within 72 hours provides a 4.25% discount, thereby changing the price from $0.08 per page (as shown in FIG. 2) to $0.0766 per page. Further, in the example illustrated in FIG. 3, preparing material for job type ‘A’ within 72 hours has a change of 0%, which can indicate that the original price ($0.03 per page) in the price table 50 illustrated in FIG. 2 is still valid.

Additionally, as shown in FIG. 3, several cells are marked with an ‘X’. This can indicate that PSP 1 is unable to deliver material for a particular type of job within a particular timeframe (e.g., due to existing obligations). For instance, FIG. 3 can indicate that PSP 1 is unable to fulfill a print order for a job of type ‘C’ in the same day or within 24 hours of receiving the print order.

Referring back to FIG. 1, the print order can be provided to the print order system 4 from a client computer 18 employed by a user 20. In one example, the client computer 18 can communicate with the print order system 4 via a browser 22 (e.g., a web browser) over the network 3. The print order can include specifications for printing, such as paper type (e.g., size, whiteness, weight, gloss, etc.), ink type, (e.g., 4 color, 6 color, black and white, etc.) binding (e.g., book binding, magazine binding, loose leaf, etc.), printing style (e.g., single-sided, duplex, etc.), finishing (e.g., varnish, laminate), language, etc. Further, the print order can include a destination. The destination can be implemented as an address to which at least a portion of the print order is to be sent. Moreover, the print order can include multiple destinations. In some examples, a document to be printed can be included with the print order.

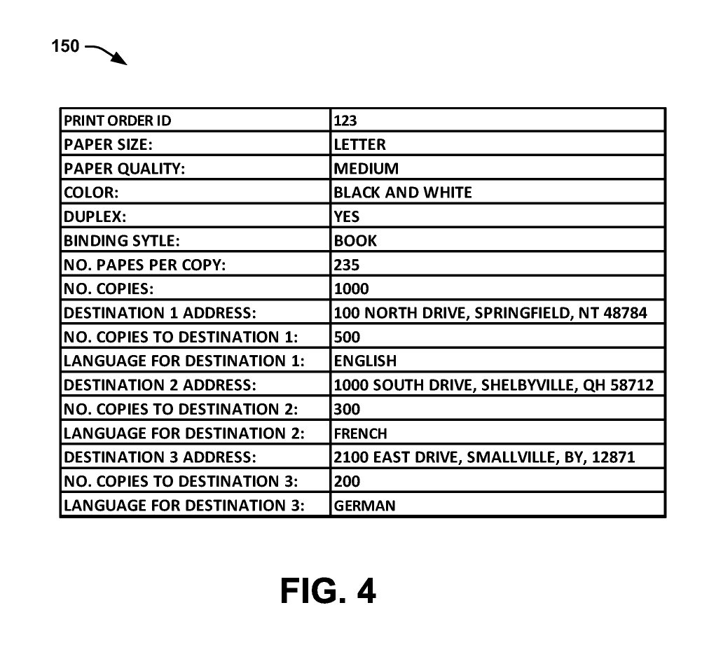

FIG. 4 illustrates an example of data 150 that can be included with a print order. In FIG. 4, a plurality of print order fields have corresponding values. One print order field can include a print order identifier (labeled in FIG. 4 as “PRINT ORDER ID”) that identifies the print order. In the example illustrated in FIG. 4, the print order can request 1000 copies of a 235 page book printed in duplex in black and white on medium quality, letter sized (e.g., 8.5 by 11 inch) paper. Further, in the present example, 500 English copies of the book are to be shipped to destination 1, 300 French copies of the book are to be shipped to destination 2, and 200 German copies of the book are to be shipped to destination 3. In other examples, more or less print order fields can be employed.

Referring back to FIG. 1, in response to receipt of the print order, a print order analyzer 24 of the print order hub 10 can process the print order to determine an optimized solution for fulfilling the print order. To determine the optimized solution, the print order analyzer 24 can access the database 16 and retrieve a PSP record for each of the PSPs 12. As noted, each PSP 12 record includes a price table and a price update table for each PSP 12. The print order analyzer 24 can examine a price table and price update table for each PSP 12 to determine a lowest cost method for fulfilling a print job for a timeframe, which method can be referred to as the cost optimized solution for the timeframe. For instance, for a print order corresponding to a print job type ‘A’ illustrated in FIG. 2, based on a price table and a price update table associated with PSP 1 of the PSPs 12, as well as a price table and a price update table associated with PSP 2 of the PSPs 12, it may be determined that PSP 1 of the PSPs 12 can provide a lowest cost to fulfill the print job in the same day, while PSP 2 of the PSPs 12 can provide a lowest cost to fulfill the print job within 24 hours.

In some examples, the print order analyzer 24 can base the determination of the cost optimized solution on calculated shipping costs for shipping material prepared for the print order. The print order analyzer 24 can calculate the shipping costs, for example, based on the destination address in the print order and an address of each PSP 12. In one example, the shipping costs can be determined by examining a shipping lookup table that indexes shipping costs per pound and size with zip codes. The print order analyzer 24 can determine and/or estimate the weight of the package needed to ship the print order based on the number of pages per copy in the print order, the number of copies in the print order, the type of binding used in the print order, the quality of the paper for the print order, etc. Due to costs associated with shipping, (e.g., due to geographical distances weather patterns, etc.) in some situations, the costs for fulfilling the print order can change the PSP 12 that provides the lowest cost to fulfill the print order in a particular timeframe. For example, in a given situation it can be presumed that for a given job type a first PSP 12 can fulfill the print order for $0.03 per page within 48 hours, while a second PSP 12 can fulfill the print order for $0.04 per page within 48 hours. In the given situation, the print order analyzer 24 may determine that the second PSP 12 provides the lowest cost for fulfilling the print order if the print order analyzer 24 calculates that shipping costs from the first PSP 12 compared to the second PSP 12 exceed savings provided by the first PSP 12 (e.g., $0.01 per page).

In some examples, the calculation of the shipping costs can leverage relationships with the PSPs 12 and shippers. For example, the print order system 4 can track print orders provided to the PSPs 12. In some situations, a given PSP 12 may receive a discount (e.g., 10%) from a shipper if the given PSP 12 ships a certain number of units in a given day (e.g., a presorted zip code discount). In a situation where the number is 500 units, and a given PSP 12 already has other pending print orders for that would cause 400 units to be shipped in the given day, the print order analyzer 24 can apply the discount to the shipping costs if the fulfillment of the print order (or some portion thereof) would cause the given PSP 12 to meet or exceed the number of units needed for the discount. In this manner, print order analyzer 24 can further optimize the search for the cost optimized solution to fulfill the print order.

In yet other examples, the print order analyzer 24 may determine that employing multiple PSPs 12 to fulfill the print order provides the cost optimized solution. For instance, as illustrated and described with respect to FIG. 4, the print order can have multiple destinations. In such a situation, the print order analyzer 24 can calculate shipping costs for each destination from each PSP 12. Upon such a calculation, it can be determined in the cost optimized solution, that a first portion of the print order (e.g., a portion designated for destination 1) be prepared by and shipped from a first PSP 12, while a second portion of the print order (e.g., a portion designated for destination 2) be prepared and shipped from a second PSP 12. Each PSP 12 identified in the cost optimized solution can be referred to as a selected PSP 12.

Upon determination of the cost optimized solution for a timeframe, the print order analyzer 24 can provide the client computer 18 with a total cost to fulfill the print order in the timeframe. The total cost can include the price charged for preparation of the material at the selected PSP 12 plus the cost of shipping the material to the destination identified in the print order. In some examples, the print order analyzer 24 can provide different total costs for different timeframes and quantity to the client computer 18. The user 20 can then elect to proceed with the print order, or to cancel the print order. If the user 20 elects to cancel the order, no further action is needed. However, the user 20 can employ the client computer 18 to submit a new print order with different specifications to determine if such a change in specifications would result in a change to the total cost for a given timeframe.

If the user 20 elects to proceed (e.g., execute) with the print order, the user 20 can employ the client computer 18 to provide the print order analyzer 10 with payment information. The payment information can include, for example, personal information of the user 20, a credit card number, a bank account number, etc. Upon receipt of the payment information and the document, the print order hub 10 can forward the document and the payment information to the print order client 14 of each selected PSP 12 in the cost optimized solution. Additionally, the print order hub 10 can provide data of the print order needed to fulfill the portion of the print order assigned to each selected PSP 12. Additionally or alternatively, in some examples, the print order analyzer 24 can employ the payment information to charge the user directly and an agreed payment can be provided to each selected PSP 12 at that time or a later time. In such a situation, the print order analyzer can forward payment (e.g., the agreed payment) to each selected PSP 12 in the cost optimized solution.

Upon receipt of the print order, the document and the payment information, each selected PSP 12 in the cost optimized solution can fulfill a portion of the print order. Fulfillment of the portion of the print order can include, but is not limited to, for example, translating, printing, binding and shipping material for the print order.

In some examples, information related to the total cost for fulfillment of the print order that is provided to the client computer 18 for the user 20 can exclude an identification of the each selected PSP 12 in the cost optimized solution. By excluding such information, the user 20 would be unable to and/or hindered from providing the print order directly to each PSP 12 and requesting a price quote for fulfilling the print order. Additionally or alternatively, certain information regarding each selected PSP 12 can be provided to the client computer 18 for the user 20. Such information can include a regional location or status (e.g. an environmental or “green” status) of each selected PSP 12. Such information may influence the user's 20 decision whether to proceed with the print order. Further, the price table and price update table for a given PSP 12 can be hidden by the print order hub 10 from the other PSPs 12. In this manner, the given PSP 12 is unable to and/or hindered from basing the price table and/or the price update table of the given PSP 12 on prices charged by other PSPs 12. Accordingly, “price wars” caused by a bidding of print orders and/or direct price comparison between PSPs 12 can be avoided. Avoidance of such price wars can increase the likelihood that operation of the PSPs 12 remains profitable.

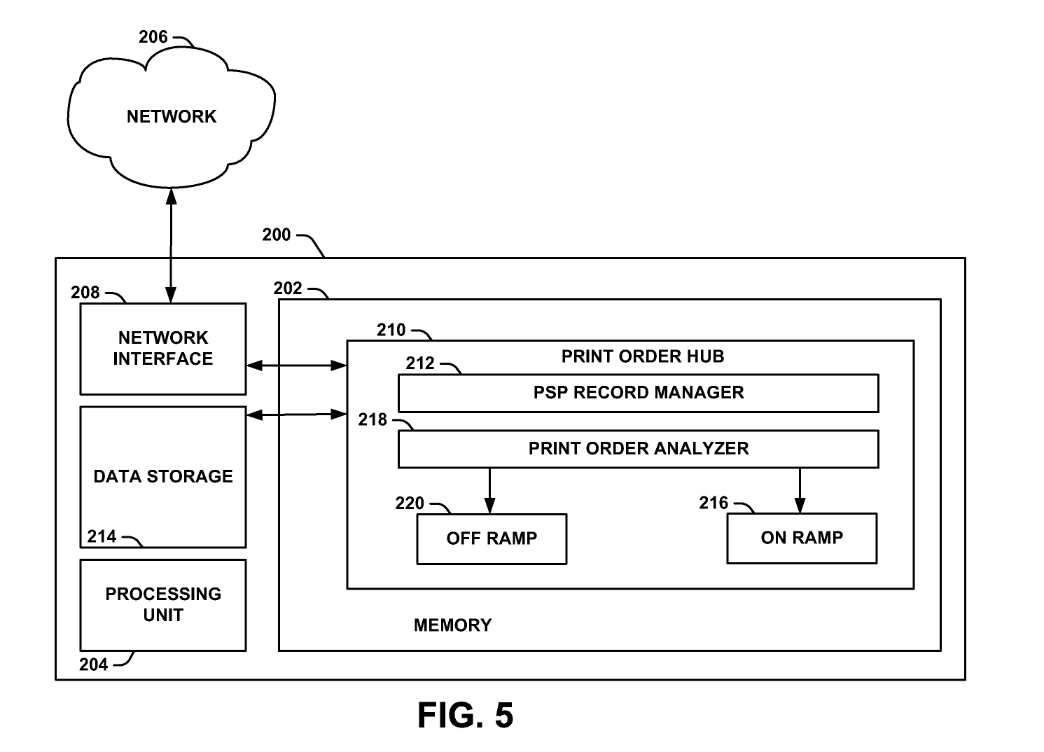

FIG. 5 illustrates an example of a print order system 200 that can be utilized to implement, for example, the print order system 4 illustrated in FIG. 1. The print order system 200 can include a memory 202 for storing machine readable instructions. The memory 202 could be implemented, for example, as random access memory, flash memory, a hard disk, a combination thereof, etc. The print order system 200 can also include a processing unit 204 that can access the memory 202 and executes machine readable instructions. The processing unit 204 can be implemented, for example, as a processor core.

The print order system 200 can be coupled to a network 206 (e.g., the Internet) via a network interface 208, which could be implemented as a network interface card. The memory 202 can include a print order hub 210 that can manage a print order.

The print order hub 210 can include a PSP record manager 212 that can receive and process a price table and a price update table from a plurality of PSPs. In one example, the PSP record manager 212 can receive a price table from each PSP relatively infrequently (e.g., about once a year). The price table could be implemented, for example, in a manner similar to the price table 50 illustrated in FIG. 2. Accordingly, the price table can identify a price per page charged for a given job type delivered within a certain timeframe.

Additionally, in some examples, the PSP record manager 212 can receive a price update table from each of the PSPs (or some portion thereof) relatively frequently (e.g., once a day, once a week, once a month, etc.). The price update table could be implemented, for example, in a manner similar to the price table 100 illustrated in FIG. 3. In some examples, the price update table can be provided from each of the PSPs in regular intervals. In other examples, the PSP record manager 212 can generate and/or modify the price update table for each PSP (or some portion thereof) based, for example, on a production parameter received from each PSP, data in the price tables, factory statuses of the PSPs, etc. The PSP record manager 212 can store the price table and the price update table for each PSP and a corresponding PSP record which can in turn be stored in a data storage 214. The data storage 214 can include, for example, a database and/or a table that can store the PSP record for each PSP. The data storage 214 can be implemented, for example as volatile memory (e.g., RAM) or non-volatile memory (e.g. a hard disk and/or a flash drive). In this manner, each PSP can adjust a price per page identified in the corresponding price table to reflect current market conditions.

The print order hub 210 can include an on ramp 216 that receives a print order with a document to be printed in the print order. The on ramp 216 can provide the print order to a print order analyzer 218 of the print order hub 210. The print order analyzer 218 can evaluate the print order and retrieve a PSP record from the data storage 214 for each of the plurality of PSPs. Each PSP record can include, for example, a price table and a price update table for a given PSP. The print order hub 210 can parse the print order and each PSP record to determine a cost optimized solution for a timeframe.

The determination of the cost optimized solution by the print order analyzer 218 can be based, for example, on a comparison of an adjusted price per page charged for preparing a job of a particular type at each PSP. Additionally, the cost optimized solution can calculate shipping costs associated with the print order. Such shipping costs can include an estimate cost to ship material prepared for the print order to a destination identified in the print order. Moreover, in some situations, the cost optimized solution may call for multiple PSPs to fulfill different portions of the print order. Each PSP identified in the cost optimized solution can be referred to as a selected PSP.

Upon determination of the cost optimized solution, the print order analyzer 218 can calculate a total cost to implement the cost optimized solution. The total cost can be provided to a client computer via the network 206. In response, the print order analyzer 218 can receive a confirmation that a user of the client computer elects to proceed with the print order, such that the cost optimized solution is executed. The confirmation can include, for example, payment information from the user.

Upon receiving the payment information, the print order analyzer 218 can provide the cost optimized solution to an off ramp 220 of the print order hub 210. The off ramp 220 can provide data for executing the cost optimized solution to a print order client at each selected PSP. The data provided the print order client of a given selected PSP can include information needed by the given selected PSP to fulfill the portion print order assigned to the given PSP in the cost optimized solution. Such data can include, for example, the document associated with the print order, specifications for printing the document (e.g., paper quality and size, binding, number of copies, language, etc.). Additionally, the data can include a destination address to which material is to be shipped upon preparation of the portion of the print order assigned to the given PSP or other relevant information.

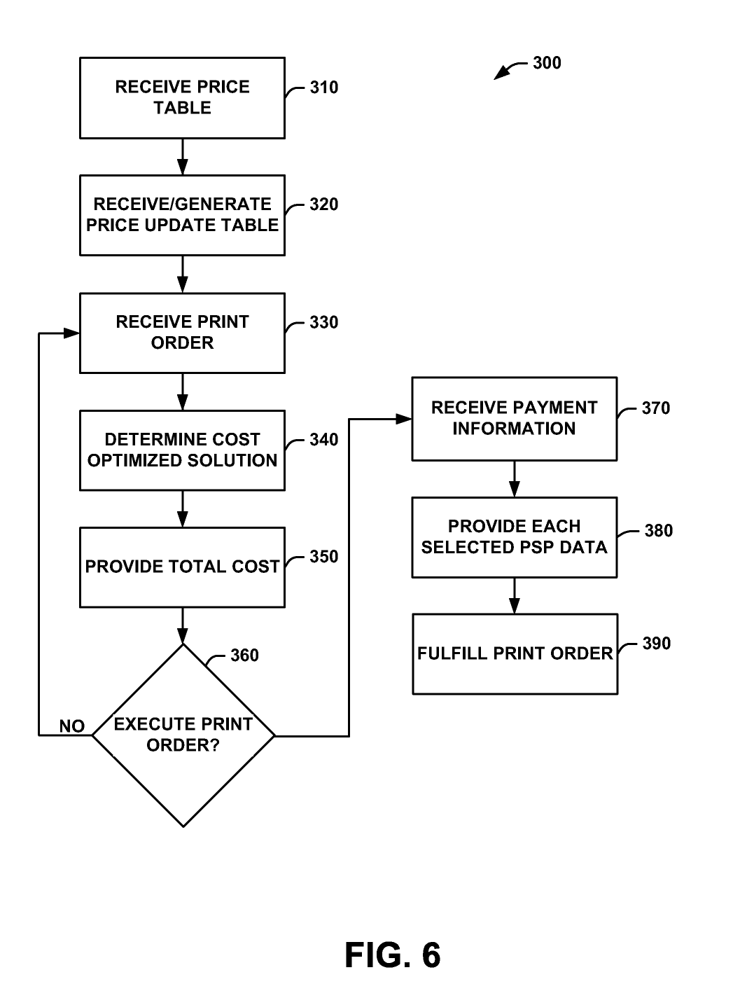

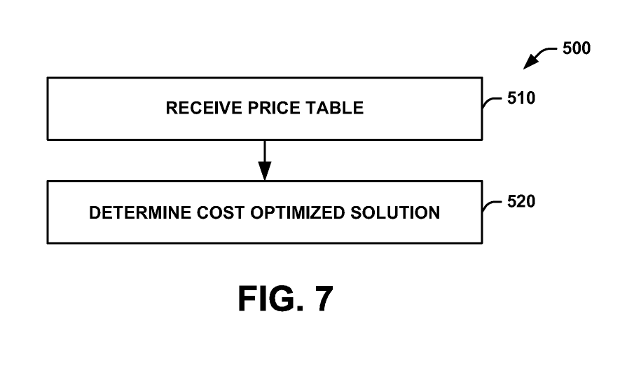

In view of the foregoing structural and functional features described above, example methods will be better appreciated with reference to FIGS. 6-7. While, for purposes of simplicity of explanation, the example methods of FIGS. 6-7 are shown and described as executing serially, it is to be understood and appreciated that the present examples are not limited by the illustrated order, as some actions could in other examples occur in different orders and/or concurrently from that shown and described herein. Moreover, it is not necessary that all described actions be performed to implement a method.

FIG. 6 illustrates a flow chart of an example method 300 for managing a print order. The method 300 could be executed, for example, by a print order system (e.g., the network system 2 illustrated in FIG. 1 and/or the print order system 200 illustrated in FIG. 4). At 310, a price table can be received from each of a plurality of print service provides (PSPs) that comprises a price charged for preparing (e.g., printing, binding, formatting, translating, etc.) a plurality of different job types in a plurality of different timeframes. Each price table can be implemented, for example, in a manner similar to the price table 50 illustrated in FIG. 2.

At 320, a price update table can be received from and/or generated for each of the plurality of PSPs (or some portion thereof). Each price update table can comprise a percentage of price change for preparing the plurality of different job types in the plurality of different timeframes. Each price update table could be implemented, for example in a manner similar to the price update table 100 illustrated in FIG. 3. The price update table for a given PSP of the plurality of PSPs can be generated based on a production parameter received from the given PSP, data in a price table for the given PSP and/or a factory status of the given PSP, etc.

At 330, a print order analyzer of the print order hub can receive a print order from a client computer. The print order can include, for example, specifications for preparing a document. The specifications can include, but are not limited to, paper type, and/or size, a number of copies to be printed, binding type, a shipping destination, etc. As one example, the print order can include the data 150 shown and described with respect to FIG. 4. Moreover, the document can be included with the print order.

At 340, a cost optimized solution for fulfilling the print order can be determined by the print order analyzer for a timeframe. The cost optimized solution can be based, for example, on an analysis of the print order, as well as a PSP record associated with each PSP. A given PSP record can include a price table, price update table associated with a given PSP or additional metrics. Additionally, the cost optimized solution can be based on a shipping cost calculated by the print order hub and/or additional requirements set by the client computer. Determination of the cost optimized solution includes a selection of a PSP to fulfill the print order. In some examples, more than one PSP can be selected to fulfill the print order. In such a situation, the cost optimized solution can assign different portions of the print order to different selected PSPs. At 350, a total cost for fulfilling the print order based on the optimized solution can be calculated and provided to the client computer.

At 360, a determination can be made as to whether to execute the print order. The determination can be based, for example, on a response to the total cost provided to the client computer. If the determination at 360 is negative (e.g., NO), in some examples, the method can return to 330. In other examples (not shown), the method can end. If the determination at 360 is positive (e.g., YES) the method 300 can proceed to 370.

At 370, the print order analyzer can receive payment information for a user of the client computer. At 380, the print order analyzer can provide each selected PSP data for fulfilling at least a portion of the print order. At 390, each selected PSP can fulfill its assigned portion of the print order. The fulfillment of the assigned portion of the print order can include, for example, preparation and shipment of material specified in the print order.

FIG. 7 illustrates another flowchart of an example method 500 for managing a print order. The method 500 could be executed, for example, by a print order system (e.g., the network system 2 illustrated in FIG. 1 and/or the print order system 200 illustrated in FIG. 4). At 510, a price table can be received (e.g., by the PSP record manager 212 illustrated in FIG. 5) from each of PSPs that comprises a price charged for preparing (e.g., printing, binding, formatting, translating, etc.) a plurality of different job types in a plurality of different timeframes. At 520, a cost optimized solution can be determined (e.g., by the print order analyzer 218 illustrated in FIG. 5) for fulfilling a print order received from a client computer. The cost optimized solution can be based on a calculated price charged for preparing material for the print order at each of the plurality of PSPs and a shipping cost for shipping the material for the print order to a destination identified in the print order.

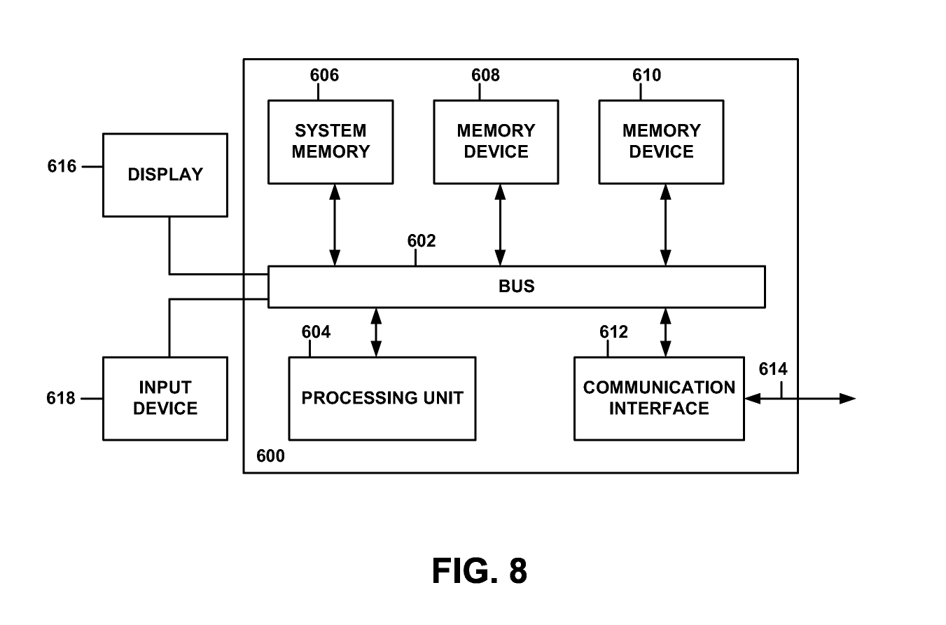

FIG. 8 is a schematic block diagram illustrating an example system 600 of hardware components capable of implementing examples disclosed in FIGS. 1-7, such as the print order system 4, the client computer 18, and portions of the of the PSPs 12 illustrated in FIG. 1 and/or the print order system 200 illustrated in FIG. 5. The system 600 can include various systems and subsystems. The system 600 can be a personal computer, a laptop computer, a workstation, a computer system, an appliance, an application-specific integrated circuit (ASIC), a server, a server blade center, a server farm, a mobile device, such as a smart phone, a personal digital assistant, etc.

The system 600 can include a system bus 602, a processing unit 604, a system memory 606, memory devices 608 and 610, a communication interface 612 (e.g., a network interface), a communication link 614, a display 616 (e.g., a video screen), and an input device 618 (e.g., a keyboard and/or a mouse). The system bus 602 can be in communication with the processing unit 604 and the system memory 606. The additional memory devices 608 and 610, such as a hard disk drive, server, stand alone database, or other non-volatile memory, can also be in communication with the system bus 602. The system bus 602 operably interconnects the processing unit 604, the memory devices 606-610, the communication interface 612, the display 616, and the input device 618. In some examples, the system bus 602 also operably interconnects an additional port (not shown), such as a universal serial bus (USB) port.

The processing unit 604 can be a computing device and can include an application-specific integrated circuit (ASIC). The processing unit 604 executes a set of instructions to implement the operations of examples disclosed herein. The processing unit can include a processor core.

The additional memory devices 606, 608 and 610 can store data, programs, instructions, database queries in text or compiled form, and any other information that can be needed to operate a computer. The memories 606, 608 and 610 can be implemented as computer-readable media (integrated or removable) such as a memory card, disk drive, compact disk (CD), or server accessible over a network. In certain examples, the memories 606, 608 and 610 can comprise text, images, video, and/or audio.

Additionally, the memory devices 608 and 610 can serve as databases or data storage such as the data storage 214 illustrated in FIG. 5. Additionally or alternatively, the system 600 can access an external system (e.g., a web service) through the communication interface 612, which can communicate with the system bus 602 and the communication link 614.

In operation, the system 600 can be used to implement, for example, a client computer, a print order hub, and at least some components of PSPs that can fulfill a print order. Computer executable logic for implementing the system, such as the memory 10 of the print order system 4 illustrated in FIG. 1 and/or the print order system 200 illustrated in FIG. 5, can reside in the system memory 606, and/or in the memory devices 608 and/or 610 in accordance with certain examples. The processing unit 604 executes one or more machine readable instructions originating from the system memory 606 and the memory devices 608 and 610. In such an example, the system memory 606 and/or the memory devices 608 and/or 610 could be employed, for example, to implement the memory 6 illustrated in FIG. 1 and/or the memory 210 illustrated in FIG. 5. The term “computer readable medium” as used herein refers to a medium that participates in providing instructions to the processing unit 604 for execution.

Where the disclosure or claims recite “a,” “an,” “a first,” or “another” element, or the equivalent thereof, it should be interpreted to include one or more than one such element, neither requiring nor excluding two or more such elements. Furthermore, what have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims.

What is claimed is:

1. A system comprising:
a memory for storing machine readable instructions; and
a processing unit for accessing the memory and executing the machine readable instructions, the machine readable instructions comprising:
a print order hub to determine a cost optimized solution for fulfilling a print order, wherein the determination of the cost optimize solution is based on a calculation of a price charged for preparing material for the print order and shipping the material for the print order to a destination identified in the print order for a plurality of print service providers (PSPs).

2. The system of claim 1, wherein the print order hub comprises a print order analyzer to calculate a total cost for fulfilling the print order based on the cost optimized solution.

3. The system of claim 1, wherein the cost optimized solution comprises a subset of the PSPs preparing different portions of the print order.

4. The system of claim 1, wherein the print order hub comprises a print order analyzer to evaluate a price table and a price update table for each of the plurality of PSPs to determine the price charged for preparing the material for the print order at the plurality of PSPs.

5. The system of claim 4, wherein each price table for each of the plurality of PSPs comprises a price charged for preparing a plurality of different job types in a plurality of different timeframes.

6. The system of claim 5, wherein each price update table for each of the plurality of PSPs comprises a percentage of price change for preparing the plurality of different job types in the plurality of different timeframes.

7. The system of claim 1, wherein the print order is provided to the print order hub from a client computer.

8. The system of claim 7, wherein the print order comprises a plurality of print order fields that define specifications for fulfilling the print order.

9. The system of claim 7, wherein the specifications define at least a paper type and the destination.

10. The system of claim 9, wherein the destination comprises at least two different destinations.

11. The system of claim 9, wherein the print order hub is further to:
calculate a total cost for fulfilling the print order; and
provide data including the total cost to the client computer.

12. A method comprising:
receiving a price table from each of a plurality of print service providers (PSPs) that comprises a price charged for preparing material for a plurality of different job types in a plurality of different timeframes; and
determine a cost optimized solution for fulfilling a print order received from a client computer, wherein the cost optimized solution is based on a calculated price charged for preparing material for the print order at each of the plurality of PSPs and a shipping cost for shipping the material for the print order to a destination identified in the print order, wherein the calculating is based on at least the price table associated with each PSP.

13. The method of claim 12, further comprising receiving a price update table from each of the plurality of PSPs, wherein each price update table for each of the plurality of PSPs comprises a percentage of price change for preparing the plurality of different job types in the plurality of different timeframes.

14. The method of claim 12, further comprising determining a price update table for a given PSP of the plurality of PSPs based on a received production parameter corresponding to an estimated production capacity for the given PSP of the plurality of PSPs, wherein the price update table for the given PSP of the plurality of PSPs comprises a percentage of price change for preparing the plurality of different job types in the plurality of different timeframes.

15. A computer readable medium having machine readable instructions comprising:
a printer order hub to manage a print order, the printer server comprising:
a print service provider (PSP) record manager to:
periodically receive a price table from each of a plurality of PSPs at a first interval, each price update table comprises a price charged for preparing material for a plurality of different job types in a plurality of different timeframes; and
periodically receive a price update table from each of the plurality of PSPs at a second interval, each price update table comprising a percentage of price change for preparing material for the plurality of different job types in the plurality of different timeframes, and quantity wherein the first interval is longer than the second interval; and
a print order analyzer to:
receive a print order from a client computer;
determine a cost optimized solution for fulfilling the print order, wherein the cost optimized solution is based on a calculation of a price charged for preparing material for the print order and shipping the material for the print order to a plurality of different destinations and the cost optimize solution comprises preparing different portions of the print order at different PSPs; and
provide a total cost for fulfilling the print order to the client computer.
